(19) United States
(12) Patent Application Publication
(10) Pub. No.: US 2008/0316521 A1
(43) Pub. Date: Dec. 25, 2008

(54) Systems and methods for managing facsimile documents

(76) Inventors: Philippe Lesage, San Diego, CA (US); Aurelio Maruggi, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/821,275

(22) Filed: Jun. 21, 2007

(51) Int. Cl. G06F 15/00

(52) U.S. Cl. 358/1.14; 358/1.16

(57) ABSTRACT

Systems and methods for managing facsimile documents can be utilized to ensure a faxed document or any portion of a faxed document is not lost. An amount of printing material available to a printing device can be determined. Based on the determined amount of printing material available, an incoming facsimile document can be printed or stored to memory to ensure that data is not lost. Similarly, an amount of available memory within a printing device can be determined to ensure that facsimile data being stored to memory is not lost due to a memory limitation. Utilizing the systems and methods disclosed, facsimile documents can be interactively managed so that information is not lost due to printing material or memory limitations.

### BACKGROUND

Generally, facsimile device users wish to receive every faxed document sent to them. Similarly, users wish to avoid documents that are difficult to read because the printing material (e.g., ink or toner) in the machine was low when the document was printed. To avoid this problem, facsimile devices may contain algorithms to estimate available printing material levels and provide various options to a user when the estimated available printing material level is getting low. Some facsimile devices assume that any inserted print cartridge (e.g., an inkjet ink cartridge or laserjet toner cartridge) is new and reset the internal printing material level counter to full when a print cartridge is inserted. This can result in an incorrect printing material level estimate if the inserted print cartridge was in fact not new (not full). Other facsimile devices have the user manually key on the device if the inserted cartridge is used or new. This can result in user entry errors, or errors due to users not knowing whether a print cartridge is new. Such facsimile devices generally do not allow a vendor to offer printing material cartridges with different fill levels for a given facsimile device as the devices would not be able to recognize a cartridge with one fill level versus a cartridge with another fill level.

In many corporate environments, stand-alone fax machines have been replaced by fax servers and other computerized systems capable of receiving and storing incoming faxes electronically, and then routing them to users on paper or via secure email. Such systems have the advantage of reducing costs by eliminating unnecessary printing and reducing the number of inbound analog phone lines needed by an office. However, some users still may desire a stand-alone facsimile device that is able to ensure that a received fax is not lost due to printing material limitations and/or facsimile device memory limitations, especially in small office and home office environments where fax servers and other computerized systems of receiving and storing incoming faxes are not available.

### BRIEF DESCRIPTION OF THE DRAWINGS

FIG. 1 is a block diagram of an exemplary system for managing facsimile documents.

FIG. 2 is a block diagram of another exemplary system for managing facsimile documents.

FIG. 3 is a block diagram of yet another exemplary system for managing facsimile documents.

FIG. 4 is a flowchart showing an exemplary method for managing facsimile documents.

FIG. 5 is a flowchart showing another exemplary method for managing facsimile documents.

FIG. 6 is a flowchart showing an exemplary method for determining an amount of printing material in a print cartridge of a facsimile device.

FIG. 7 is a flowchart showing an exemplary method of ensuring a faxed document is not lost.

FIG. 8 is a flowchart showing another exemplary method of ensuring a faxed document is not lost.

### DETAILED DESCRIPTION

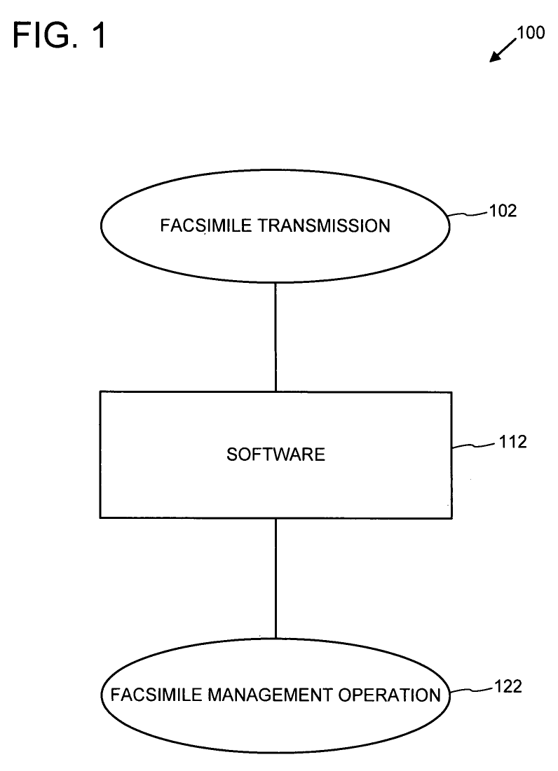

FIG. 1 shows an exemplary system 100 for managing facsimile documents. A facsimile transmission 102 (e.g., an electronic transmission representing a facsimile document) is received by a printing device having facsimile functionality and processed by software 112 to determine an appropriate facsimile management operation 122 that ensures that a facsimile document is not lost. The software 112 can combine any of the technologies described herein. Facsimile transmission 102 can include any information representing a copy of a document (e.g., image data of content printed on a physical document) or any information representing information about a copy of a document (e.g., header file information, file size information, and the like) transferred over a telephone network. A printing device having facsimile functionality can include any stand-alone printing device operable to send and receive facsimile documents, including all-in-one printing devices that can also print, copy, and/or scan documents. Throughout the application, the term printing device can mean a printing device having facsimile functionality. Therefore, the terms printing device and facsimile device can be used interchangeably. Similarly, the terms facsimile and fax can be used interchangeably and can refer to a page or a document represented by a facsimile transmission and/or printed or stored information representing (or about) a page or document that was sent or received by a facsimile transmission.

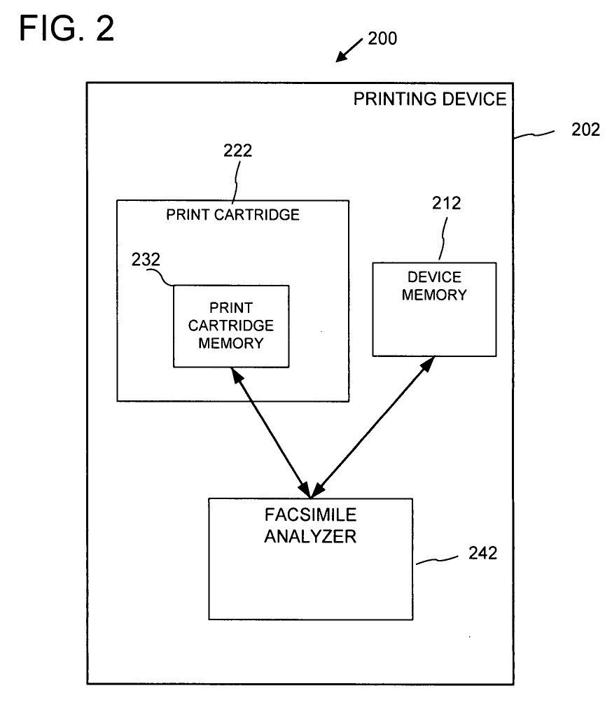

FIG. 2 shows another exemplary system 200 for managing facsimile documents. A printing device 202 operable to receive and print facsimile documents can have a device memory 212 and a facsimile analyzer 242. Device memory 212 can store printer firmware that controls operation of the printing device 202, as well as printer usage information including usage information specific to a print cartridge installed in the printing device. The printing device 202 can have a print cartridge 222 installed to provide printing material for printing. The print cartridge 222 can include print cartridge memory 232 operable to store information such as the amount of printing material in (or available to) print cartridge 222.

Facsimile analyzer 242 can be operable to communicate with device memory 212 and print cartridge memory 232 to determine when the amount of printing material in the print cartridge is below a printing material threshold (e.g., an amount of printing material necessary to print a page of a received facsimile document) and begin storing to the device memory 212 one or more pages of a facsimile document received by printing device 202. Facsimile analyzer 242 can further be operable to communicate with device memory 212 to determine when available memory in the device memory is below a predetermined memory threshold (e.g., an amount of memory necessary to store one or more pages of an incoming facsimile transmission).

Facsimile analyzer 242 can be even further operable to change the status of the printing device from a facsimile receive mode to a facsimile no receive mode when the available memory in device memory 212 is below a memory threshold. Facsimile analyzer 242 can include software (e.g., software 112 of system 100 of FIG. 1). Any of a variety of communication methods can be utilized by the facsimile analyzer including wireless (e.g., radiofrequency) communication and/or standard hardware/electrical and/or software enabled communication means known in the art.

Device memory 212, print cartridge memory 232, and any other memory discussed herein can include any type of memory operable to store information. Alternatively, RFID tags or smart card technology can be utilized having memory including read-only and/or random-access memory, an integrated circuit including a central processing unit, communication capabilities including wireless networking capabilities, or any combination thereof. This can include devices that include Dynamic Data Authentication (DDA) and similar encrypted and password-type “smart” technologies. Such devices are common to the credit card and banking industries to ensure secure transactions and correct identification, and could be utilized to ensure proper device/print cartridges are utilized.

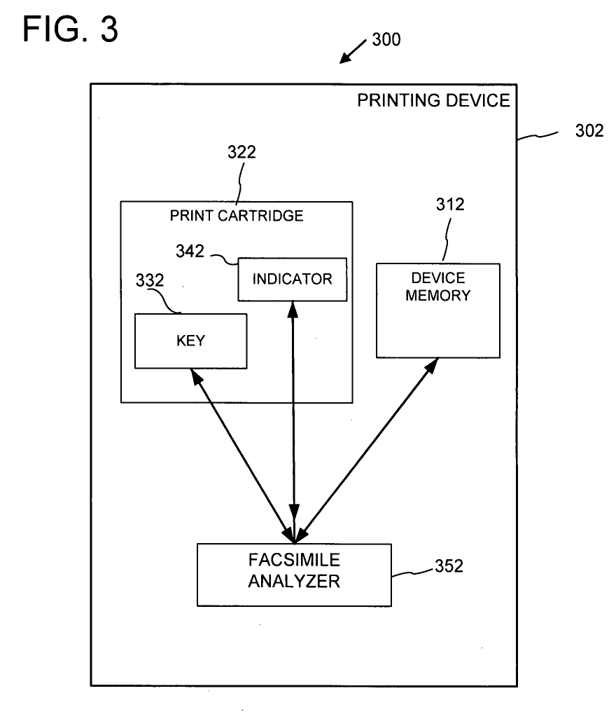

FIG. 3 shows another exemplary system 300 for managing facsimile documents. A printing device 302 operable to receive and print out facsimile documents can have a device memory 312 and a facsimile analyzer 352. Device memory 312 can store printer firmware that controls operation of the printing device 302, as well as printer usage information including usage information specific to a print cartridge installed in the printer device. The printing device 302 can have a print cartridge 322 installed to provide printing material for printing. The print cartridge 322 can include a key 332 (e.g., an RFID tag or other memory) operable to store printing material fill level information about the printing material fill level of the print cartridge 322. Alternatively, key 332 can be an identification tag having information that identifies the print cartridge. The print cartridge 322 can also include an indicator 342 (e.g., an electrical switch or any type of mechanism or mechanical switch) to indicate whether the print cartridge is a new print cartridge or a used print cartridge.

Facsimile analyzer 352 can be operable to communicate with device memory 312, key 332, and indicator 342 to determine when the amount of printing material in the print cartridge is below a printing material threshold and begin storing to the device memory 312 one or more pages of a facsimile document received by printing device 302. Facsimile analyzer 352 can further be operable to communicate with device memory 312 to determine when available memory in the device memory is below a predetermined memory threshold (e.g., an amount of memory necessary to store one or more pages of a facsimile document represented by an incoming and/or received facsimile transmission).

Facsimile analyzer 352 can be even further operable to change the status of the printing device from a facsimile receive mode to a facsimile no receive mode when the available memory in device memory 312 is below a memory threshold. Facsimile analyzer 352 can include software (e.g., software 112 of system 100 of FIG. 1). Additionally, printing device 302 can be operable to adjust the indicator 342 of the print cartridge 322 from a new indication to a used indication when a first printing operation occurs using print cartridge 322.

Printing device 302 (and printing device 202 of system 200 of FIG. 2) can be operable to provide a user with printing options when a used print cartridge is installed. Printing options can include printing one or more documents and storing to the device memory (312 of system 300 of FIG. 3 and 212 of system 200 of FIG. 2) the one or more documents.

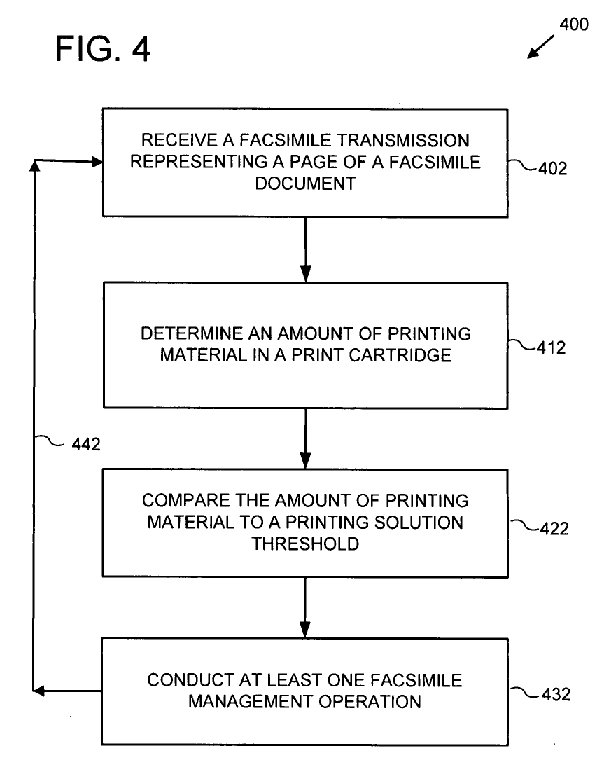

FIG. 4 shows an exemplary method 400 for managing facsimile documents. The method can be performed, for example, by system 100 of FIG. 1, system 200 of FIG. 2, and system 300 of FIG. 3. Portions of method 400 and any of the other methods (or portions of methods) described herein can be performed by computer-executable instructions stored on computer-readable media.

At 402, a facsimile transmission representing a page of a facsimile document is received. For example, printing device 202 of FIG. 2 and printing device 302 of FIG. 3 can receive the facsimile transmission representing a page of the facsimile document.

At 412, an amount of printing material in a print cartridge within a printing device can be determined when the facsimile transmission representing a page of the facsimile document is received. For example, software 112 of FIG. 1 can be utilized to determine the amount of printing material in the print cartridge. More particularly, facsimile analyzer 242 of FIG. 2 (or facsimile analyzer 352 of FIG. 3) can be utilized to determine the amount of printing material in the print cartridge.

At 422, the amount of printing material in the print cartridge can be compared to a printing material threshold. For example, software 112 of FIG. 1 can be utilized to compare the amount of printing material in the print cartridge to a printing material threshold. Specifically, facsimile analyzer 242 of FIG. 2 (or facsimile analyzer 352 of FIG. 3) can be utilized to compare the amount of printing material in the print cartridge to a printing material threshold.

At 432, at least one facsimile management operation can be conducted based on the comparison at 422. For example, facsimile management operation 122 of system 100 of FIG. 1 can be conducted. The at least one facsimile management operation can include printing a page of the facsimile document represented by the facsimile transmission when the amount of printing material in the print cartridge is at or above a print threshold and storing the page to the device memory when the amount of printing material is below the printing material threshold. A printing material threshold can be a predetermined threshold of a minimum amount of printing material necessary to print a standard page of text of a received facsimile document. Alternatively, a printing material threshold can be determined “on the fly” (e.g., dynamically) by determining the amount of text and/or the size (e.g., the file size) of the page to determine an estimated amount of printing material necessary to print the page. In such a manner, it can be possible to utilize more printing material within the print cartridge when compared to having a predetermined threshold.

At 442, the method returns to 402 to receive another facsimile transmission (or portion of the same transmission) representing another page of the facsimile document (if there are multiple pages of the facsimile document). In such a manner, method 400 can manage facsimile documents page by page as a facsimile transmission is received. As described below, facsimile documents can alternatively be managed as a group (e.g., as entire documents) instead of partial analysis (e.g., one page at a time). When analyzed one page at a time, it becomes possible to more effectively utilize available printing material within the print cartridge and storage memory within the memory device. However, with such a method it is also possible that a received multi-page facsimile document can have some pages printed out, while other pages are stored to memory (and possibly other pages rejected due to memory limitations), when utilizing techniques described below.

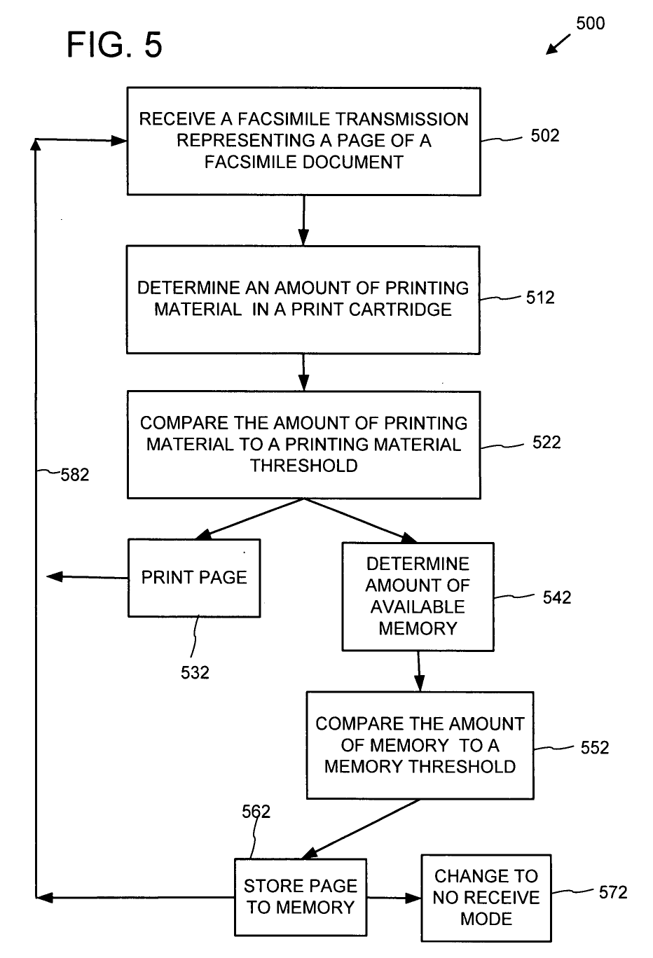

FIG. 5 shows an exemplary method 500 for managing facsimile documents. The method can be performed, for example, by system 100 of FIG. 1, system 200 of FIG. 2, and system 300 of FIG. 3. Portions of method 500 and any of the other methods (or portions of methods) described herein can be performed by computer-executable instructions stored on computer-readable media.

At 502, a facsimile transmission representing a page of a facsimile document is received. For example, printing device 202 of FIG. 2 (or printing device 302 of FIG. 3) can receive the page of the facsimile document.

At 512, an amount of printing material in a print cartridge within a printing device can be determined when the facsimile transmission representing a page of the facsimile document is received. For example, software 112 of FIG. 1 can be utilized to determine the amount of printing material in the print cartridge. In particular, facsimile analyzer 242 of FIG. 2 (or facsimile analyzer 352 of FIG. 3) can be utilized to determine the amount of printing material in the print cartridge.

At 522, the amount of printing material in the print cartridge can be compared to a printing material threshold. For example, software 112 of FIG. 1 can be utilized to compare the amount of printing material in the print cartridge to a printing material threshold. Specifically, facsimile analyzer 242 of FIG. 2 (or facsimile analyzer 352 of FIG. 3) can be utilized to compare the amount of printing material in the print cartridge to a printing material threshold.

At 532, the received page of the facsimile document can be printed after the comparison 522 determines that the amount of printing material in the print cartridge is equal to or above a printing material threshold amount necessary to print the page. As described above in method 400, a printing material threshold can be a predetermined threshold of a minimum amount of printing material necessary to print a standard page of text of a received facsimile document. Alternatively, a printing material threshold can be determined “on the fly” (e.g., dynamically) by determining the amount of text and/or the size (e.g., the file size) of the page to determine an estimated amount of printing material necessary to print the page. In such a manner, it can be possible to utilize more printing material within the print cartridge when compared to having a predetermined threshold.

At 542, an amount of available memory in a memory device of a facsimile device can be determined after the printing material comparison at 522 determined that the amount of printing material in the print cartridge is below a printing material threshold amount necessary to print the page represented by the received facsimile transmission.

At 552, the amount of available memory in the memory device can be compared to a predetermined memory threshold (e.g., a minimum amount of available memory necessary to store a page of a standard page of text of a received facsimile document). Alternatively, a memory threshold can be determined “on the fly” (e.g., dynamically) by determining the amount of text and/or the size (e.g., the file size) of the page to determine an estimated amount of memory necessary to store the page to memory. In such a manner, it can be possible to utilize more memory within the device memory when compared to having a predetermined memory threshold.

At 562, the received page can be stored to memory after memory comparison 552 determines that the amount of available memory in the memory device is equal to or above a memory threshold amount necessary to store the page to memory.

At 572, the printing device can be changed from a facsimile receive mode to a facsimile no receive mode after memory comparison 552 determines that the amount of available memory in the memory device is below a memory threshold amount necessary to store another page to memory. To ensure that facsimile documents are not lost, the printing device can remain in the no receive mode until a user inserts another print cartridge having printing material and/or deletes stored pages from memory. Alternatively, in some embodiments, for example, it may be possible for a user to increase available memory by utilizing compression techniques or incorporating alternative memory means (e.g., inserting removable memory cards).

At 582, the method returns to 502 to receive another facsimile transmission (or portion of the same transmission) representing another page of the facsimile document (if there are multiple pages of the facsimile document). In such a manner, method 500 can manage facsimile documents page by page as facsimile transmissions representing pages of facsimile documents are received. As described below, facsimile documents can alternatively be managed as a group (e.g., as entire documents) instead of partial analysis (e.g., one page at a time). When analyzed one page at a time, it becomes possible to more effectively utilize available printing material within the print cartridge and storage memory within the memory device. However, with such a method it is also possible that a received multi-page facsimile document can have some pages printed out, while other pages are stored to memory (and possibly other pages rejected due to memory limitations).

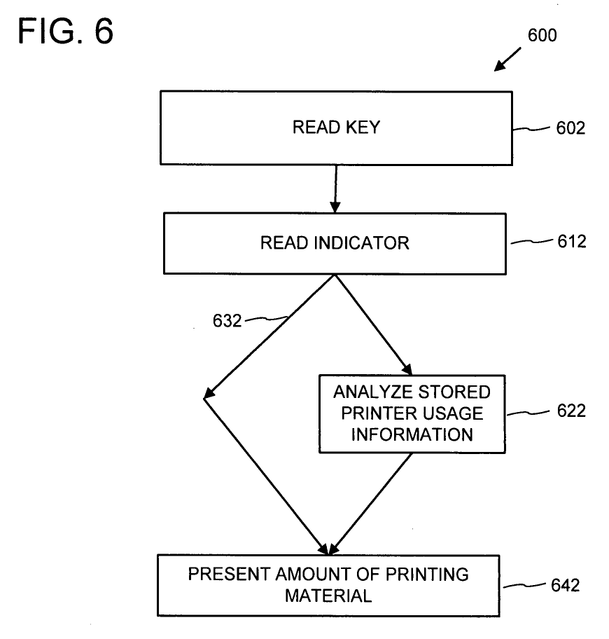

FIG. 6 shows an exemplary method 600 for determining an amount of printing material in a print cartridge of a facsimile device. The method can be performed, for example, by system 300 of FIG. 3. Further, the method can be utilized at 412 of method 400 of FIG. 4 (or at 512 of method 500 of FIG. 5). Method 600 can be performed by software 112 of system 100 of FIG. 1, as well as performed by computer-executable instructions stored on computer-readable media.

At 602, a key on a print cartridge installed in a facsimile device can be read. For example, key 332 of system 300 of FIG. 3 can be read. The key can have printing material fill level information. Alternatively, the key can have identifying information (e.g., a model number or model type) that can be read to identify the print cartridge. Printing material fill level information can be stored on device memory in a facsimile device for a variety of print cartridges (e.g., a variety of models). Print material fill information for the installed print cartridge can therefore be determined by associating the identifying information in the key with the print material fill information stored in the device memory for the corresponding print cartridge variety (e.g., model).

At 612, an indicator on the print cartridge installed in a facsimile device can be read. For example, indicator 342 of system 300 of FIG. 3 can be read. The indicator can indicate whether the print cartridge is a new cartridge or a used cartridge. In some embodiments, the indicator can also indicate what type (e.g., a model number or model type) of print cartridge is installed. As described above utilizing key identifying information, the print material fill information can be determined via association of the type of print cartridge with information (e.g., print material fill information) about the type of print cartridge stored on the device memory. In such an embodiment, the key and indicator can be combined.

At 622, stored printer usage information can be analyzed to determine an amount of printing material used since a print cartridge was inserted into the facsimile device, if the indicator indicated that the print cartridge installed in the facsimile device is a used cartridge. This determined amount of printing material used can be subtracted from the printing material fill level amount read from the key (or from the device memory) to determine the amount of printing material currently in the print cartridge.

At 632, analyzing stored printer usage information 622 can be bypassed if the indicator indicated that the print cartridge installed in the facsimile device is a new cartridge. In such a situation, the printing material fill level amount read from the key (or the device memory) is determined to be the current amount of printing material in the print cartridge.

At 642, the amount of printing material in the print cartridge can be presented. For example, the amount of printing material can be presented for comparison at 422 of method 400 of FIG. 4 (or at 522 of method 500 of FIG. 5) to use in the comparison with a printing material threshold as part of methods of managing facsimile documents.

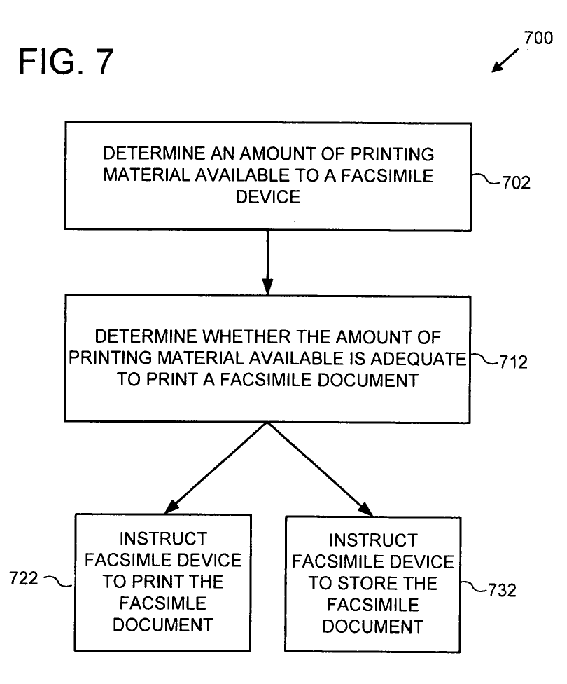

FIG. 7 shows an exemplary method 700 of ensuring a faxed document is not lost. The method can be performed, for example, by system 200 of FIG. 2 or system 300 of FIG. 3. Method 700 can be performed by software 112 of system 100 of FIG. 1, as well as performed by computer-executable instructions stored on one or more computer-readable media.

At 702, an amount of printing material available to a facsimile device can be determined. For example, method 600 of FIG. 6 can be utilized to determine the amount of printing material in the print cartridge.

At 712, whether the amount of printing material available is adequate to print a facsimile document can be determined. For example, the facsimile device can receive initial information within a facsimile transmission that a certain number of pages of a facsimile document are incoming. An amount of printing material necessary to print out the amount of incoming pages can be determined. For example, this can be determined by utilizing a predetermined average amount of printing material necessary to print an average received page of text (e.g., a predetermined printing material threshold for a page) and multiplying it by the number of pages incoming. Alternatively, file size information about the incoming number of pages can be utilized to determine an amount of printing material necessary to print out the incoming pages.

At 722, the facsimile device can be instructed to print the facsimile document based on the determination at 712 that there is an adequate amount of printing material available to print the facsimile document.

At 732, the facsimile device can be instructed to store the facsimile document based on the determination at 712 that there is not an adequate amount of printing material available. It could also be possible to instruct the facsimile device to print a selected number of one or more pages for which there is adequate printing material available to print such one or more pages and to store other selected one or more pages for which there is not adequate printing material available. Utilizing both printing and storing functionality for a multi-page facsimile document enables a facsimile document to not be lost or rejected.

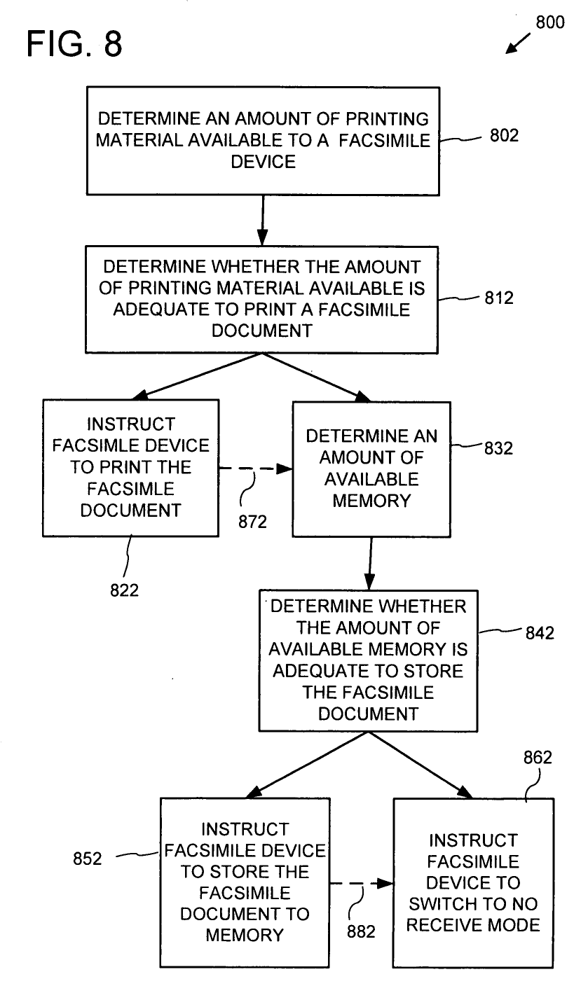

FIG. 8 shows another exemplary method 800 of ensuring a faxed document is not lost. The method can be performed, for example, by system 200 of FIG. 2 or system 300 of FIG. 3. Method 800 can be performed by software 112 of system 100 of FIG. 1, as well as performed by computer-executable instructions stored on one or more computer-readable media.

At 802, an amount of printing material available to a facsimile device can be determined. For example, method 600 of FIG. 6 can be utilized to determine the amount of printing material in the print cartridge of the facsimile device.

At 812, whether the amount of printing material available is adequate to print a facsimile document can be determined. For example, the facsimile device can receive initial information within a facsimile transmission that a certain number of pages of a facsimile document are incoming. An amount of printing material necessary to print out the amount of incoming pages can be determined. For example, this can be determined by utilizing a predetermined average amount of printing material necessary to print an average received page of text (e.g., a predetermined printing material threshold for a page) and multiplying it by the number of pages incoming. Alternatively, for example, file size information about the incoming facsimile document can be utilized to determine an amount of printing material necessary to print out the incoming pages.

At 822, the facsimile device can be instructed to print the facsimile based on the determination at 812 that there is an adequate amount of printing material available to print the facsimile document.

At 832, an amount of available device memory in the facsimile device can be determined after it was determined at 812 that there is not an adequate amount of printing material available. It could also be possible to instruct the facsimile device to print a selected number of pages for which there is adequate printing material available to print such pages and to then store (or attempt to store) other selected pages for which there is not adequate printing material available, as illustrated at 872. Utilizing both printing and storing functionality for a multi-page facsimile document enables a facsimile document to not be lost or rejected.

At 842, whether the amount of available device memory is adequate to store the facsimile document can be determined. For example, the facsimile device can receive initial information within the facsimile transmission that a certain number of pages of a facsimile document are incoming. An amount of memory necessary to store the amount of incoming pages can be determined. For example, this can be determined by utilizing a predetermined average amount of memory necessary to store an average received page of text (e.g., a predetermined memory threshold for a page) and multiplying it by the number of pages incoming. Alternatively, for example, file size information about the incoming facsimile document can be utilized to determine an amount of memory necessary to store the incoming pages.

At 852, the facsimile device can be instructed to store the facsimile document to memory based on the determination at 842 that there is an adequate amount of memory available.

At 862, the facsimile device can be instructed to change to a no receive mode and reject the facsimile document based on the determination at 842 that there is not an adequate amount of memory available. Such an instruction can ensure that partial facsimile documents are not received leading to possible confusion for the recipient and/or the sender about the status of a facsimile document. Alternatively, It could also be possible to instruct the facsimile device to store a selected number of one or more pages for which there is adequate memory available to store such one or more pages and to reject (e.g., switch to a no receive mode) other selected one or more pages for which there is not adequate memory available, as illustrated at 882. Utilizing both storing and rejecting functionality for a multi-page facsimile document enables a facsimile document to be partially received and maximize memory use, while also notifying the sender (and recipient) of the facsimile that only a portion of the entire facsimile document was received.

The disclosure set forth above encompasses multiple distinct embodiments. While each of these embodiments have been disclosed in its preferred form, the specific embodiments as disclosed and illustrated herein are not to be considered in a limiting sense as numerous variations are possible. The subject matter of the present disclosure includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

What is claimed is:

1. A system for managing facsimile documents comprising:
a printing device operable to receive and print a facsimile document, wherein the printing device has a device memory and a facsimile analyzer, the facsimile analyzer operable to determine whether an amount of available printing material is below a printing material threshold, and upon determining the amount of printing material is below the printing material threshold to begin storing to the device memory one or more pages of the facsimile document received.

2. The system of claim 1, wherein the facsimile analyzer is further operable to communicate with the device memory to determine whether available memory in the device memory is below a memory threshold.

3. The system of claim 2, wherein the facsimile analyzer is further operable to change the status of the printing device from a facsimile receive mode to a facsimile no receive mode where the available memory in the device memory is below the memory threshold.

4. The system of claim 1, wherein the printing device is further operable to perform at least one of printing, copying, and scanning documents.

5. The system of claim 1, wherein the printing material threshold is a minimum amount of printing material necessary to print a page of a received facsimile document.

6. The system of claim 2, wherein the memory threshold is a minimum amount of memory necessary to store a page of a received facsimile document.

7. The system of claim 1, further comprising a print cartridge operable for providing printing material for printing, wherein the print cartridge has a cartridge memory operable to at least store information for determining an amount of printing material in the print cartridge.

8. The system of claim 7, wherein the print cartridge further comprises an indicator operable to indicate whether the print cartridge is a new print cartridge or a used print cartridge

9. The system of claim 8, wherein the facsimile analyzer is further operable to read the indicator of the print cartridge.

10. The system of claim 9, wherein the printing device is further operable to adjust the indicator of the print cartridge from a new indication to a used indication when a first printing operation occurs.

11. The system of claim 9, wherein the printing device is further operable to provide a user with printing options when a used print cartridge is installed.

12. The system of claim 11, wherein the printing options comprise at least one of printing one or more documents and storing to the device memory the one or more documents.

13. The system of claim 7, wherein the cartridge memory comprises a key.

14. The system of claim 13, wherein the key includes printing material fill level information on the printing material fill level of the print cartridge.

15. The system of claim 8, wherein the printing device is further operable to provide a warning communication when the facsimile analyzer is unable to at least one of communicate with the cartridge memory, read the indicator, and communicate with the device memory.

16. The system of claim 1, further comprising a print cartridge operable for providing printing material for printing, wherein the print cartridge has identifying information for determining a model type of the print cartridge.

17. The system of claim 16, wherein the device memory is operable to store information on the amount of printing material in a new print cartridge model type, and the facsimile analyzer is operable to read the identifying information on the print cartridge and associate the stored information on the amount of printing material in the new print cartridge model type with the print cartridge to determine an amount of printing material in the print cartridge.

18. A method for managing facsimile documents comprising:
receiving a page of a facsimile document in a printing device operable to receive facsimile documents, the printing device having device memory;
determining an amount of printing material available to a print cartridge within the printing device upon receiving a page of the facsimile document,
comparing the amount of printing material in the print cartridge to a printing material threshold; and
printing the page of the facsimile document where the amount of printing material in the print cartridge meets or exceeds the printing material threshold, and storing the page of the facsimile document to the device memory where the amount of printing material is below the printing material threshold.

19. The method of claim 18, wherein the printing material threshold is a minimum amount of printing material necessary to print the page of the facsimile document.

20. The method of claim 18, further comprising determining an amount of available memory in the device memory.

21. The method of claim 20, further comprising comparing the amount of available memory in the device memory to a memory threshold.

22. The method of claim 21, further comprising changing a status of the printing device from a facsimile receive mode to a facsimile no receive mode where the available device memory is below a memory threshold.

23. The method of claim 21, wherein the memory threshold is a minimum amount of memory necessary to store the page of the facsimile document.

24. The method of claim 18, wherein print cartridge information is stored on at least one of an indicator on the print cartridge and a key on the print cartridge.

25. The method of claim 24, wherein determining the amount of printing material available to the print cartridge comprises determining print cartridge use information.

26. The method of claim 25, wherein determining print cartridge use information comprises at least one of:
determining an amount of printing material in a new print cartridge; and
determining an amount of printing material in a used print cartridge.

27. The method of claim 26, wherein determining an amount of printing material in a new print cartridge comprises reading the indicator on the print cartridge and reading the key on the print cartridge.

28. The method of claim 26, wherein determining an amount of printing material in a new print cartridge comprises reading the indicator on the print cartridge, reading the key on the print cartridge, and communicating with the device memory.

29. The method of claim 26, wherein determining an amount of printing material in a used print cartridge comprises reading the indicator on the print cartridge, reading the key on the print cartridge, and communicating with the device memory.

30. The method of claim 24, wherein the indicator on the print cartridge indicates whether the print cartridge is a new cartridge or a used cartridge.

31. The method of claim 30, further comprising adjusting the indicator on the print cartridge from a new indication to a used indication when a first printing operation occurs.

32. The method of claim 24, wherein the key on the print cartridge indicates printing material fill level information on the printing material fill level of the print cartridge.

33. The method of claim 28, wherein the key on the print cartridge indicates identifying information for determining a model type of the print cartridge, and wherein communicating with the device memory comprises associating stored information on the amount of printing material in the new print cartridge model type with the print cartridge to determine an amount of printing material in the print cartridge.

34. The method of claim 29, wherein communicating with the device memory comprises analyzing stored printer usage information to determine an amount of printing material from the print cartridge that the printing device has used.

35. A method of ensuring a faxed document is not lost, the method comprising:
determining an amount of printing material available to a facsimile device;
determining whether the amount of printing material available is adequate to print a facsimile document; and
instructing the facsimile device to print the facsimile document where there is an adequate amount of printing material to print the facsimile document, and to store to a memory device of the facsimile device the facsimile document where there is not an adequate amount of printing material to print the facsimile document.

36. The method of claim 35, further comprising determining an amount of available memory within the memory device of the facsimile.

37. The method of claim 36, further comprising determining whether the amount of available memory is adequate to store the facsimile document.

38. The method of claim 37, further comprising instructing the facsimile device to store the facsimile document to the memory device where there is an adequate amount of available memory to store the facsimile document, and to switch the facsimile device to a no receive mode where there is not an adequate amount of available memory is to store the facsimile document.

39. Computer-readable media comprising computer-executable instructions for performing the method of claim 35.
